(19) United States
(12) Patent Application Publication
(10) Pub. No.: US 2021/0197347 A1
(43) Pub. Date: Jul. 1, 2021

(54) Pocket Screwdriver

(71) Applicant: Richard J. Macor, Easton, PA (US)

(72) Inventor: Richard J. Macor, Easton, PA (US)

(21) Appl. No.: 16/602,949

(22) Filed: Dec. 31, 2019

(51) Int. Cl. B25B 23/16; B25G 1/08

(52) U.S. Cl. CPC B25B 23/16; B25G 1/08

(57) ABSTRACT

A pocket screwdriver that comprises two separate screwdrivers. Each screwdriver has a handle and a screwdriver shaft with at least one working tip. The at least one working tip of one screwdriver is different than the at least one working tip of the other screwdriver. Each screwdriver handle is formed with a hollow space configured to substantially house the screwdriver shaft and the at least one tip of the other screwdriver, whereby, the two screwdrivers may be assembled together so that the shaft and the at least one tip of each screwdriver is substantially non-exposed to prevent the potential for accidental user injury.

### REFERENCES TO RELATED APPLICATIONS

This patent application may relate to one or more of the following patents granted to the inventor herein including U.S. Pat. Nos. D380,363; 5,592,862; and D373,061.

This application directly relates to and is a continuation-in-part of co-pending U.S. patent application Ser. No. 29/742,081 filed on Nov. 25, 2019 entitled POCKET SCREWDRIVER HALF also filed by the inventor herein.

### FIELD OF THE INVENTION

The present invention relates to screwdrivers, particularly screwdrivers that may be carried and transported in a user's pocket.

### BACKGROUND OF THE INVENTION

Screwdrivers made for turning screws, small nuts and bolts have been used by users for more than a century. Traditional prior-art screwdrivers have a handle, a shaft and an exposed working tip which is usually pointed and sharp. Accordingly, if a user carries a screwdriver in their pocket, or attempts to find and grab a screwdriver out of a packed toolbox, kitchen drawer, car glovebox, pocketbook etc., there's a possibility the user may be injured from the exposed pointed sharp screwdriver tip.

Certainly, screwdrivers can be improved to reduce the possibility of users stabbing and/or injuring themselves from the exposed pointed sharp tip if carried in a pocket and/or grabbed from a packed toolbox, kitchen drawer, car glovebox, pocketbook, etc.

### SUMMARY OF THE INVENTION

A pocket screwdriver that comprises two separate screwdrivers. Each screwdriver has a handle and a screwdriver shaft with at least one working tip. The at least one working tip of one screwdriver is different than the at least one working tip of the other screwdriver. Each screwdriver handle is formed with a hollow space configured to substantially house the screwdriver shaft and the at least one tip of the other screwdriver, whereby, the two screwdrivers may be assembled together so that the shaft and the at least one tip of each screwdriver is substantially non-exposed to prevent the potential for accidental user injury.

It is an objective of the present invention Pocket Screwdriver described herein that it provides multiple screwdriver tips to turn multiple types of screws, nuts and bolts.

It is another objective of the present invention that it does not have any sharp or pointed parts substantially exposed so that it may be safely carried in a user's pocket.

It is another objective of the present invention that it does not have any sharp or pointed parts exposed so that it may be safely grabbed out of a packed toolbox, kitchen drawer, car glovebox, and/or pocketbook etc.

It is another objective of the present invention that it provides users with enhanced turning leverage to aid old and/or weak users who may have weak hands and/or wrists.

It is another objective of the present invention that it be ergonomic and comfortable to use.

It is another objective of the present invention that it be simple in design.

It is another objective of the present invention that it be durable under extended use.

It is another objective of the present invention that it be commercially viable and cost-efficient to manufacture.

### BRIEF DESCRIPTION OF THE DRAWINGS

The present invention is more fully understood when the specification herein is taken in conjunction with the drawings appended hereto, wherein:

FIG. 1 shows a top partial cross-sectional view of an example embodiment of the present invention Pocket Screwdriver comprising two separate screwdrivers;

FIG. 2 shows a top view of the present invention Pocket Screwdriver shown in FIG. 1 with the two screwdrivers detached from each other for individual usage;

FIG. 3 shows a right-side elevation end view of the screwdriver at the left in FIGS. 1 and 2;

FIG. 4 shows a left side elevation end view of the screwdriver at the right in FIGS. 1 and 2.

FIG. 5 shows a top partial cross-sectional view of an example embodiment of the present invention Pocket Screwdriver comprising two separate screwdrivers;

FIG. 6 shows a top view of the present invention Pocket Screwdriver shown in FIG. 5 with the two screwdrivers detached from each other for individual usage;

FIG. 7 shows a right-side elevation end view of the screwdriver at the left in FIGS. 5 and 6;

FIG. 8 shows a left side elevation end view of the screwdriver at the right in FIGS. 5 and 6.

### DETAILED DESCRIPTION OF THE DRAWINGS

The various drawings provided herein are for the purpose of illustrating examples of the present invention and not for the purpose of limiting same. Therefore, the drawings herein represent only a few of the many possible examples, embodiments, variations and/or applications of the present invention.

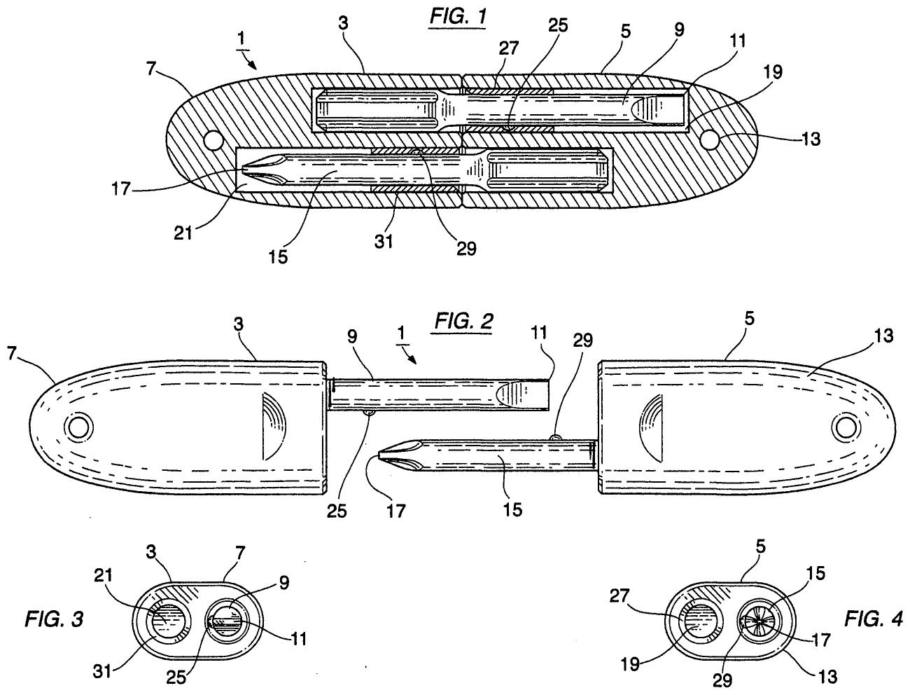

Referring now to FIGS. 1, 2, 3 and 4 together, FIG. 1 shows a top partial cross-sectional view of an example embodiment of the present invention Pocket Screwdriver comprising two separate screwdrivers; and, FIG. 2 shows a top view of the present invention Pocket Screwdriver shown in FIG. 1 with the two screwdrivers detached from each other for individual usage; and, FIG. 3 shows a right-side elevation end view of the screwdriver at the left in FIGS. 1 and 2; and, FIG. 4 shows a left side elevation end view of the screwdriver at the right in FIGS. 1 and 2. Pocket Screwdriver 1 comprises two separate screwdrivers 3 and 5 each having a handle (shown in a cross-sectional view in FIG. 1) and a screwdriver shaft with at least one working tip. Screwdriver 3 has a handle 7, shaft 9 and tip 11. Screwdriver 5 has a handle 13, shaft 15 and tip 17. Note that the at least one working tip 11 of screwdriver 3 is different than the at least one working tip 17 of the other screwdriver 5. Each screwdriver handle is formed having a hollow space configured to substantially house the screwdriver shaft and the at least one tip of the other screwdriver, whereby, the two screwdrivers 3 and 5 may be assembled together so that the shaft and the at least one tip of each screwdriver is substantially non-exposed to prevent the potential for accidental user injury and improve portability as shown in FIG. 1. Accordingly, the shaft 9 and tip 11 of screwdriver 3 are housed within the hollow space 19 formed in the handle 13 of screwdriver 5. Likewise, the shaft 15 and tip 17 of screwdriver 5 are housed within the hollow space 21 formed in the handle 7 of screwdriver 3. In preferred embodiments of the present invention, at least one of the two screwdrivers is formed with means to detachably secure both screwdrivers together. In this example embodiment of the present invention, the shaft 9 of screwdriver 3 has a spring-loaded ball 25 which snaps into a socket hole in metal sleeve 27 in the cavity 19 of screwdriver 5; and, the shaft 15 of screwdriver 5 has a spring-loaded ball 29 which snaps into a socket hole in metal sleeve 31 in the cavity 21 of screwdriver 3. This arrangement detachably secures screwdriver 3 together with screwdriver 5 so Pocket Screwdriver 1 may be safely carried in a user's pocket with the shaft and the at least one tip of each screwdriver substantially non-exposed to prevent the potential for accidental user injury. Of course, a magnetic means or frictional means (or a combination thereof) could alternatively be used to detachably secure screwdriver 3 together with screwdriver 5.

The shape of Pocket Screwdriver 1 could be any shape whatsoever, however, preferred embodiments of the present invention Pocket Screwdriver have a silhouette shape when viewed from a top view thereof, and that shape is substantially an elongated ellipse as seen in FIG. 1.

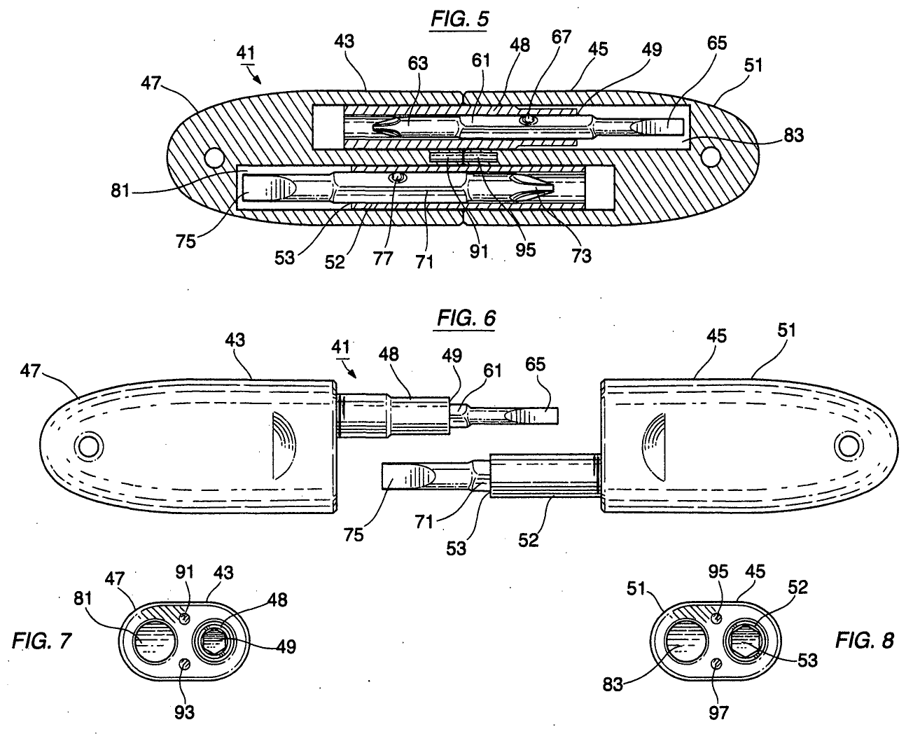

Referring now to FIGS. 5, 6, 7 and 8 together, FIG. 5 shows a top partial cross-sectional view of an example embodiment of the present invention Pocket Screwdriver comprising two separate screwdrivers; and, FIG. 6 shows a top view of the present invention Pocket Screwdriver shown in FIG. 5 with the two screwdrivers detached from each other for individual usage; and, FIG. 7 shows a right-side elevation end view of the screwdriver at the left in FIGS. 5 and 6 but with the double-ended screwdriver bit removed; and, FIG. 8 shows a left side elevation end view of the screwdriver at the right in FIGS. 5 and 6 but with the double-ended screwdriver bit removed. In this example embodiment of the present invention Pocket Screwdriver 41 has two separate screwdrivers 43 and 45 each having a handle (shown in a cross-sectional view in FIG. 5) and a screwdriver shaft with a working end. Accordingly, screwdriver 43 has handle 47, shaft 48 and working end 49; and, screwdriver 45 has handle 51, shaft 52 and working end 53. The working end of each screwdriver shaft is substantially hollow as best seen in FIGS. 5, 7 and 8. The working end 49 of shaft 48 of screwdriver 43 best seen in FIG. 7 is substantially hollow. And, the working end 53 of shaft 52 of screwdriver 45 best seen in FIG. 8 is substantially hollow.

Each substantially hollow shaft 48 and 52 of screwdrivers 43 and 45 respectively is configured to detachably hold at least one double-ended screwdriver bit having at least two working tips, whereby, each screwdriver has at least two different working screwdriver tips. Accordingly, screwdriver 43 has a double-ended screwdriver bit 61 with a small Phillip's head working tip 63 on one end and a small Slotted head working tip 65 on the other end thereof. Double-ended screwdriver bit 61 also has a spring-loaded ball 67 best seen if FIG. 5 that frictionally holds screwdriver bit 61 within hollow shaft 48. In FIG. 6, screwdriver 43 has the small slotted head working tip 65 exposed for use, however, a user would simply pull the screwdriver bit out of shaft 48, turn it around and re-insert it into shaft 48 to expose the small Phillip's head working tip 63 for use. Similarly, screwdriver 45 has a double-ended screwdriver bit 71 with a large Phillip's head working tip 73 on one end; and, a large Slotted head working tip 75 on the other end thereof. Both working tips 73 and 75 of screwdriver 45 are larger than tips 63 and 65 respectively of screwdriver 43 so that Pocket Screwdriver 41 has at least 4 different working tips. Double-ended screwdriver bit 71 also has a spring-loaded ball 77 best seen in FIG. 5 that frictionally holds screwdriver bit 71 within hollow shaft 52. In FIG. 6, screwdriver 45 has the large Slotted head working tip 75 exposed for use, however, a user would simply pull the screwdriver bit 71 out of shaft 52, turn it around and re-insert it into shaft 52 to expose the large Phillip's head working tip 73 for use.

Screwdriver handle 47 of screwdriver 43 is formed having a hollow space 81 configured to substantially house the screwdriver shaft 52 and the at least one double-ended screwdriver bit 71 of the other screwdriver 45. And, screwdriver handle 51 of screwdriver 45 is formed having a hollow space 83 configured to substantially house the screwdriver shaft 48 and the at least one double-ended screwdriver bit 61 of the other screwdriver 43, whereby, the screwdrivers 43 and 45 may be assembled together so that the shaft and the at least one double-ended screwdriver bit of each screwdriver is substantially non-exposed to prevent the potential for accidental user injury and improve portability.

In preferred embodiments of the present invention, at least one of the two screwdrivers is formed having a means to detachably secure both screwdrivers together when assembled as shown in FIG. 5. In this example embodiment of the present invention, cylindrical magnets 91 and 93 are pressed into the handle 47 of screwdriver 43 best seen in FIG. 7; and, cylindrical magnets 95 and 97 are pressed into handle 51 of screwdriver 45 best seen in FIG. 8. This arrangement detachably secures screwdriver 43 together with screwdriver 45 by a magnetic means so Pocket Screwdriver 41 may be safely carried in a user's pocket with the shaft and the at least one double-ended screwdriver bit of each screwdriver substantially non-exposed to prevent the potential for accidental user injury. Of course, a spring-loaded ball or frictional means (or a combination thereof) could alternatively be used to detachably secure screwdriver 43 together with screwdriver 45.

As shown in FIG. 7 the substantially hollow shaft 48 of screwdriver 43 is configured with a hexagonal opening 49 which is the working end of shaft 48. And, as shown in FIG. 8 the substantially hollow shaft 52 of screwdriver 45 is configured with a hexagonal opening 53 which is the working end of shaft 52. Importantly, the hexagonal opening 49 in the shaft 48 of screwdriver 43 is different in size than the hexagonal opening 53 in the shaft 52 of screwdriver 45 providing a user with two different hexagonal sockets to turn at least two different size nuts/bolts when the screwdriver bits are removed. Accordingly, in some preferred embodiments of the present invention, the working end of each screwdriver shaft is configured with a hexagonal opening, and the hexagonal opening of one screwdriver shaft is different in size that the hexagonal opening of the other screwdriver shaft. Accordingly, Pocket Screwdriver 41 provides a user with four different working screwdriver tips; and, two different nut/bolt driving sockets.

The shape of Pocket Screwdriver 41 could be any shape whatsoever, however, preferred embodiments of the present invention Pocket Screwdriver have a silhouette shape when viewed from a top view thereof, and that shape is substantially an elongated ellipse as seen in FIG. 5.

Upon reading and understanding the specification of the present invention described above, modifications and alterations will become apparent to those skilled in the art. It is intended that all such modifications and alterations be included insofar as they come within the scope of the patent as claimed or the equivalence thereof.

1. A pocket screwdriver comprising:
two separate screwdrivers each having a handle and a screwdriver shaft with at least one working tip;
the at least one working tip of one screwdriver being different than the at least one working tip of the other screwdriver;
each screwdriver handle formed having a hollow space configured to substantially house the screwdriver shaft and the at least one tip of the other screwdriver, whereby, the two screwdrivers may be assembled together so that the shaft and the at least one tip of each screwdriver is substantially non-exposed to prevent the potential for accidental user injury; and,
at least one said screwdriver being formed having means to detachably secure both said screwdrivers together when assembled; and,
further wherein the two assembled screwdrivers have a silhouette shape when viewed from a top view thereof, and the silhouette shape is substantially an elongated ellipse.

2. (canceled)

3. The pocket screwdriver of claim 1 wherein a magnetic means is used to detachably secure the two screwdrivers together when assembled.

4. The pocket screwdriver of claim 1 wherein at least one spring-loaded ball is used to detachably secure the two screwdrivers together when assembled.

5. The pocket screwdriver of claim 1 wherein a frictional means is used to detachably secure the two screwdrivers together when assembled.

6. The pocket screwdriver of claim 2 wherein a magnetic means is used to detachably secure the two screwdrivers together when assembled.

7. The pocket screwdriver of claim 2 wherein at least one spring-loaded ball is used to detachably secure the two screwdrivers together when assembled.

8. The pocket screwdriver of claim 2 wherein a frictional means is used to detachably secure the two screwdrivers together when assembled.

9. A pocket screwdriver comprising:
two separate screwdrivers each having a handle and a screwdriver shaft with a working end;
the working end of each screwdriver shaft being substantially hollow and configured to detachably hold at least one double-ended screwdriver bit having at least two working tips, whereby, each said screwdriver has at least two different working screwdriver tips;
each screwdriver handle formed having a hollow space configured to substantially house the screwdriver shaft and the at least one double-ended screwdriver bit of the other screwdriver, whereby, the two screwdrivers may be assembled together so that the shaft and the at least one double-ended screwdriver bit of each screwdriver is substantially non-exposed to prevent the potential for accidental user injury; and,
at least one said screwdriver being formed having means to detachably secure both said screwdrivers together when assembled.

10. The pocket screwdriver of claim 9 wherein the two assembled screwdrivers have a silhouette shape when viewed from a top view thereof, and the silhouette shape is substantially an elongated ellipse.

11. The pocket screwdriver of claim 9 wherein a magnetic means is used to detachably secure the two screwdrivers together when assembled.

12. The pocket screwdriver of claim 9 wherein at least one spring-loaded ball is used to detachably secure the two screwdrivers together when assembled.

13. The pocket screwdriver of claim 9 wherein a frictional means is used to detachably secure the two screwdrivers together when assembled.

14. The pocket screwdriver of claim 10 wherein a magnetic means is used to detachably secure the two screwdrivers together when assembled.

15. The pocket screwdriver of claim 10 wherein at least one spring-loaded ball is used to detachably secure the two screwdrivers together when assembled.

16. The pocket screwdriver of claim 10 wherein a frictional means is used to detachably secure the two screwdrivers together when assembled.

17. The pocket screwdriver of claim 9 wherein the working end of each screwdriver shaft is configured with a hexagonal opening, and the hexagonal opening of one screwdriver shaft is different in size that than the hexagonal opening of the other screwdriver shaft.

18. The pocket screwdriver of claim 17 wherein a magnetic means is used to detachably secure the two screwdrivers together when assembled.

19. The pocket screwdriver of claim 17 wherein at least one spring-loaded ball is used to detachably secure the two screwdrivers together when assembled.

20. The pocket screwdriver of claim 17 wherein a frictional means is used to detachably secure the two screwdrivers together when assembled.

21. The pocket screwdriver of claim 10 wherein the working end of each screwdriver shaft is configured with a hexagonal opening, and the hexagonal opening of one screwdriver shaft is different in size than the hexagonal opening of the other screwdriver shaft.

22. The pocket screwdriver of claim 21 wherein a magnetic means is used to detachably secure the two screwdrivers together when assembled.

23. The pocket screwdriver of claim 21 wherein at least one spring-loaded ball is used to detachably secure the two screwdrivers together when assembled.

24. The pocket screwdriver of claim 21 wherein a frictional means is used to detachably secure the two screwdrivers together when assembled.
